(19) United States
(12) Patent Application Publication
(10) Pub. No.: US 2011/0176009 A1
(43) Pub. Date: Jul. 21, 2011

(54) CLIENT DEVICE AND CONTROL METHOD THEREOF, AND IMAGE SERVICE SYSTEM INCLUDING THE SAME

(75) Inventors: Byung Kwon CHOI, Seoul (KR); Woo Sup Han, Yongin-si (KR); Tae Sin Ha, Seoul (KR)

(73) Assignee: Samsung Electronics Co., Ltd., Suwon-si (KR)

(21) Appl. No.: 13/006,017

(22) Filed: Jan. 13, 2011

(30) Foreign Application Priority Data
Jan. 15, 2010 (KR) 10-2010-0003988

(51) Int. Cl. G06K 9/36; H04N 5/225

(52) U.S. Cl. 348/207.1; 382/239; 348/384.1; 348/E05.024

(57) ABSTRACT

A client device, a control method thereof, and an image service system including the client service and the control method are disclosed. The client device includes an image capturing unit to capture an image, an encoding unit to encode the image captured by the image capturing unit into a JPEG format according to a group map that includes not only Frames Per Second (FPS) values required for types of a plurality of image services but also compression information for each frame image, and a client controller to determine not only the FPS satisfying the plurality of image services but also the compression information for each frame image, and control an operation of the encoding unit in such a manner that images captured by the image capturing unit are encoded according to the determined FPS and compression information. As a result, the client device differently encodes the quality of an image captured by a camera according to image service types, and reduces the file size of the encoded image, resulting in an increase in the transmission efficiency of image.

### CROSS-REFERENCE TO RELATED APPLICATIONS

This application claims the priority benefit of Korean Patent Application No. 10-2010-0003988, filed on Jan. 15, 2010 in the Korean Intellectual Property Office, the disclosure of which is incorporated herein by reference.

### BACKGROUND

1. Field

Embodiments relate to a client device for encoding an image captured by a camera into a Joint Photographic Experts Group (JPEG) stream, a method for controlling the client device, and an image service system including the client device.

2. Description of the Related Art

Generally, an image captured by a camera installed in a client device such as a robot has been widely used in a variety of services, for example, face recognition, object recognition, navigation, monitoring, etc.

A client device serving as an image service device transmits a captured image to a server device for providing a variety of image services. However, in order to effectively provide a variety of image services such as face recognition, object recognition, navigation, monitoring, and the like, images having various qualities while being classified according to categories of image services are needed.

For example, the face recognition service may require a 320*240-sized image having a frame rate of 15 fps (frames per second) or more, and the object recognition service may require a 640*480-sized image having a frame rate of 5 fps or more. In this way, there are various kinds of image qualities capable of providing the best services of individual image service types.

In order to simultaneously satisfy two kinds of image services under the above-mentioned condition, it is necessary for an image having at least 15 fps to be transferred to the size of 640*480-sized image, such that two kinds of image services can be simultaneously satisfied.

Generally, in order to transmit images for a robot, JPEG streams have been widely used. Transmission of most robot images has been frequently processed for every scene, such that JPEG streams capable of being processed for every scene have been widely used.

In the case of making a JPEG file for each frame image, the quality of the JPEG file can be decided using an image-quality vector (Q-factor). In order to implement the face recognition service or the object recognition service, a high-quality image is needed. The monitoring service and the navigation service do not require a good image quality better than that of the face recognition service or the object recognition service.

Therefore, in order to satisfy all kinds of the image services, parameters, i.e., 640*480, 15 fps, and Q-factor 100, need to be applied to two cameras. Under the above-mentioned condition, the overall JPEG file size is increased, much load is applied to the network, transmission time becomes longer and the possibility of unexpectedly severing a transmission image becomes higher, such that the unexpected problems are encountered in image services. That is, the related art system has been designed to satisfy all kinds of image services when transmitting image data, such that the transmission efficiency is deteriorated and a large number of unnecessary images are intermittently transmitted, resulting in increased network load.

### SUMMARY

Therefore, it is an aspect to provide a client device for differently encoding the quality of an image captured by a camera according to categories of image services to increase the transmission efficiency of the captured image, a method for controlling the client device, and an image service system including the client device and the control method thereof.

It is another aspect to provide a client device for differently encoding the quality of an image transmitted to a server device according to categories of image service supplied from a server device to reduce the network load between the server device and the client device, a control method thereof, and an image service system including the client device and the control method thereof.

Additional aspects of the invention will be set forth in part in the description which follows and, in part, will be obvious from the description, or may be learned by practice of the invention.

In accordance with one aspect, a client device includes an image capturing unit to capture an image, an encoding unit to encode the image captured by the image capturing unit into a JPEG format according to a group map that includes not only Frames Per Second (FPS) values required for types of a plurality of image services but also compression information for each frame image, and a client controller to determine not only the FPS satisfying the plurality of image services but also the compression information for each frame image, and control an operation of the encoding unit in such a manner that images captured by the image capturing unit are encoded according to the determined FPS and compression information.

The compression information of the group map may include at least one of an image size and a Q-factor indicating an image quality vector.

The client controller may determine the FPS satisfying the plurality of image services to be the highest FPS in the group map.

In association with each frame image having the determined FPS, according to the group map, the client controller may determine an image size of a corresponding frame image to be a maximum image size from among image sizes corresponding to an image service used in the corresponding frame image, and determine a Q-factor of the corresponding frame image to be a maximum Q-factor from among Q-factors corresponding to the image service used in the corresponding frame image.

In accordance with another aspect, an image service system includes a receiving unit to receive a group map that includes not only Frames Per Second (FPS) values required for types of a plurality of image services provided from a server but also compression information from the server, an image capturing unit to capture an image, an encoding unit to encode the image captured by the image capturing unit into a JPEG format, a client controller to determine not only the FPS satisfying the plurality of image services but also the compression information for each frame image according to the group map received through the receiving unit, and control an operation of the encoding unit in such a manner that images captured by the image capturing unit are encoded according to the determined FPS and compression information for each frame image, and a transmitter to transmit the encoded images to the server according to a control signal from the client controller.

The compression information of the group map may include at least one of an image size and a Q-factor indicating an image quality vector.

The client controller may determine the FPS satisfying the plurality of image services to be the highest FPS in the group map.

The client controller, in association with each frame image having the determined FPS, according to the group map, determines an image size of a corresponding frame image to be a maximum image size from among image size values corresponding to an image service used in the corresponding frame image, and determines a Q-factor of the corresponding frame image to be a maximum Q-factor from among Q-factors corresponding to the image service used in the corresponding frame image.

In accordance with another aspect, a method for controlling a client device includes capturing an image, determining, according to a group map that includes not only Frames Per Second (FPS) values required for types of a plurality of image services but also image sizes and Q-factors for individual frame images, the FPS satisfying the plurality of image services, an image size and a Q-factor for each frame image, and encoding the captured images into a JPEG format according to the determined FPS and the determined image size and Q-factor for each frame image.

The determining of the FPS and the image size and Q-factor for each frame image may include determining the FPS satisfying the plurality of image services to be the highest FPS in the group map, determining, in association with each frame image having the determined FPS, an image size of a corresponding frame image in the group map to be a maximum image size from among image sizes corresponding to an image service used in the corresponding frame image, and determining a Q-factor of the corresponding frame image in the group map to be a maximum Q-factor from among Q-factors corresponding to the image service used in the corresponding frame image.

In accordance with another aspect, an image service method includes receiving a group map that includes not only Frames Per Second (FPS) values required for types of a plurality of image services provided from a server but also an image size and a Q-factor indicating an image quality vector from the server, determining not only the FPS satisfying the plurality of image services but also an image size and Q-factor for each frame image according to the received group map, capturing an image, encoding the captured images into a JPEG format according to the determined FPS and compression information for each frame image, and transmitting the encoded images to the server.

The determining of the FPS and the image size and Q-factor for each frame image may include determining the FPS satisfying the plurality of image services to be the highest FPS in the group map, and determining, in association with each frame image having the determined FPS, an image size of a corresponding frame image in the group map to be a maximum image size from among image sizes corresponding to an image service used in the corresponding frame image, and determining a Q-factor of the corresponding frame image in the group map to be a maximum Q-factor from among Q-factors corresponding to the image service used in the corresponding frame image.

### BRIEF DESCRIPTION OF THE DRAWINGS

These and/or other aspects of the invention will become apparent and more readily appreciated from the following description of the embodiments, taken in conjunction with the accompanying drawings of which:

FIG. 1 illustrates an image service system according to an embodiment invention.

FIG. 2 illustrates an image service system according to an embodiment invention.

FIG. 3 illustrates image information of individual image service categories provided from a server device of an image service system according to an embodiment invention.

FIGS. 4A and 4B respectively illustrate the number of frames per second of a left image and the number of frames per second of a right image, where the left and right images satisfy all kinds of image services shown in FIG. 3.

FIG. 5 illustrates individual frame images shown in FIG. 4A according to service categories, image sizes, and Q-factors to be used in the individual frame images.

FIG. 6 illustrates individual frame images shown in FIG. 4B according to service categories, image sizes, and Q-factors to be used in the individual frame images.

FIG. 7 illustrates an image service method according to an embodiment.

FIG. 8 illustrates a method for deciding Frames Per Second (FPS) according to group maps by a client device of an image service system according to an embodiment.

FIG. 9 illustrates a method for deciding an image size for each frame image according to group maps by a client device of an image service system according to an embodiment.

FIG. 10 illustrates a method for deciding a Q-factor for each frame image according to group maps by a client device of an image service system according to an embodiment.

### DETAILED DESCRIPTION

Reference will now be made in detail to the embodiments invention, examples of which are illustrated in the accompanying drawings, wherein like reference numerals refer to like elements throughout.

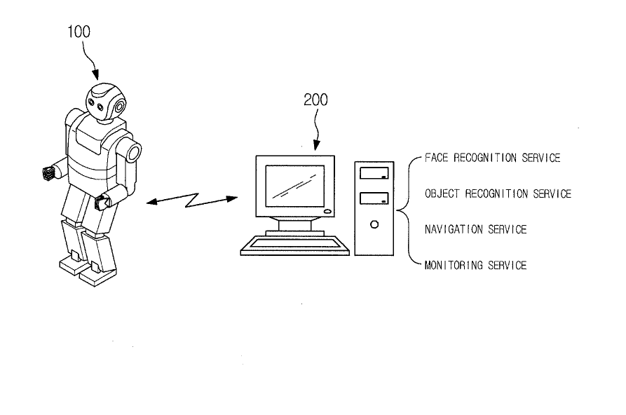

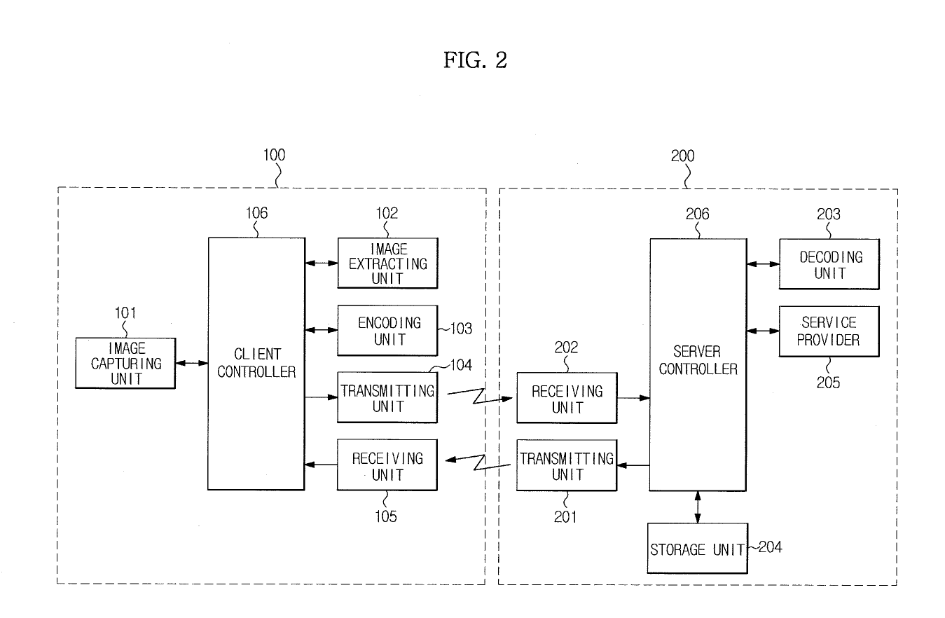

FIG. 1 illustrates an image service system according to an embodiment invention. FIG. 2 is a control block diagram illustrates an image service system according to an embodiment.

Referring to FIG. 1, an image service system according to an embodiment includes a client device 100 and a server device 200 connected to the client device over a network. The client device 100 serves as an image service device, collects and processes images captured by a camera, and transmits the processed images. The server device 200 receives the images from the client device 100, and provides a variety of image services to a user. For example, the client device 100 may be a robot capable of performing network communication and including a camera.

The camera may capture images and may also provide the captured images in real time. Also, the camera may collect captured images for a predetermined period of time and then provide the collected images.

The client device 100 collects images provided from the camera. Also, the client device 100 stores the collected images, and properly processes the stored images into other images required for an image service in such a manner that the stored images can be used in the server device 200. Then, the client device 100 may compress the processed images, and transmits the compressed images to the server device 200. However, it is understood that the client device 100 also may send the processed image without compressing.

The server device 200 receives images from the client device 100, and recovers the received images, such that it provides a proper image service.

Meanwhile, the client device 100 simultaneously performs a variety of image processes using the images. The server device 200 requesting such images requests images of various qualities according to a variety of image service categories, for example, a face recognition service, an object recognition service, a navigation service, a monitoring service, etc. However, if the client device 100 transmits a predetermined-quality image capable of satisfying all the image services requested by the server device 200, the file size of transmitted image is increased and the transmission efficiency is decreased, such that a large amount of load is encountered in the network. In addition, assuming that the stereo camera is used, the size of conventional image file is increased at least two fold, such that network traffic may be excessively increased.

Therefore, the client device for use in the image service system according to an embodiment differently decides the quality of captured images according to categories of image services to increase the transmission efficiency of images captured by the camera, and then encodes the individual images having different qualities.

In order to reduce network load between the server device and the client device by the image service system according to the embodiment, the client device differentiates the quality of images provided from the server device according to image service categories provided from the server device, and then encodes the differentiated images.

That is, the client device 100 receives the number of frames per second requested by individual image service categories and information including compression information from the server device 200, decides the number of frames per second satisfying all the image services requested by the server device 200 and compression information of each frame image according to the received information, and differently encodes the image quality using the decided number of frames per second and the decided compression information for each frame image. As a result, the client device 100 can convert the captured images into other images having proper qualities suitable for all the image service categories requested by the server device 200, and transmit the converted images, such that network load between the client device 100 and the server device 200 is reduced.

Referring to FIG. 2, the client device 100 includes an image capturing unit 101, an image extracting unit 102, an encoding unit 103, a transmitting unit 104, a receiving unit 105, and a client controller 106.

The image capturing unit 101 may capture or photographs a stereo image. The image capturing unit 101 may include a stereo camera. The stereo camera outputs a stereo image. The stereo image includes both a left-view image (i.e., a left image) and a right-view image (right image) of the same scene. The stereo camera capable of acquiring such stereo image is generally classified into a binocular camera and a monocular camera. The monocular camera acquires image of different viewpoints using only one camera. The binocular camera acquires images of different viewpoints using two cameras.

The image extracting unit 102 extracts each of a left image and a right image from the image captured by the image capturing unit 101.

The encoding unit 103 encodes the left image of the stereo image captured by the image capturing unit 101 into a JPEG format, and encodes the right image of the stereo image into a JPEG format.

The transmitting unit 104 transmits the left and right image data encoded into the JPEG format to the server device 200.

The receiving unit 105 receives information transmitted by the server device 200. For example, the received information may include not only the number of frames per second requested for individual image services provided from the server device 200, but also information in which compression information of each frame is recorded.

The client controller 106 receives the information transmitted from the server device 200 from the receiving unit 105, controls the image capturing unit 101 to capture the stereo image, and controls the image extracting unit 102 to separate/extract each of a left image and a right image from the stereo image captured by the image capturing unit 101. The client controller 106 controls the encoding unit 103 to encode each of the right image and the left image extracted by the image extracting unit 102 into a JPEG format, and controls the transmitting unit 104 to transmit left image data and right image data JPEG-encoded by the encoding unit 103 to the server device 200 through transmitting unit 104.

Also, the server device 200 may include a transmitting unit 201, a receiving unit 202, a decoding unit 203, a storage unit 204, a service provider 205, and a server controller 206.

The transmitting unit 201 transmits information to the client device 100.

The receiving unit 202 receives left image data and right image data from the client device 100.

The decoding unit 203 decodes the left image data and the right image data received through the receiving unit 202 such that the left image data and the right image data can be restored to an original image.

The storage unit 204 stores the decoded image.

The server controller 206 transmits information to the client device 100 through the transmitting unit 201, receives left image data and right image data from the client device 100 through the receiving unit 202, decodes the left image data and the right image data received in the receiving unit 202 through the decoding unit 203 such that the received left and right image data can be restored to a general image.

Then, the server controller 206 stores the decoded image in the storage unit 204, and provides various image services (e.g., face recognition, object recognition, navigation, monitoring, etc.) using the decoded image stored in the storage unit 204 through the service provider 205. The service provider 205 searches for an image corresponding to the image service type provided from the service provider 205 in images of various qualities, and provides a corresponding image service suitable for the searched image.

The client device 100 transmits the image captured by the camera to the server device 200 providing image services. The server device 200 analyzes the image transmitted from the client device 100, such that it informs the client device 100 of the corresponding information or provides an image service to a user.

Generally, an image size, and the number of frames per second (FPS) are differently determined according to image service types provided from the server device 200. Also, the quality of an image service is decided in response to image quality.

Hereinafter, structures and operations of four services for employing an image acquired by the client device 100 according to the embodiments invention will hereinafter be described.

A requested image quality varies according to image service types provided from the server device 200. Therefore, the server device 200 requires different image qualities for various image services.

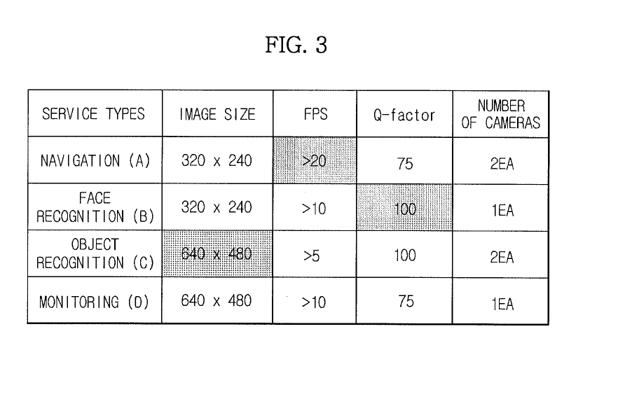

For example, as shown in FIG. 3, image information (such as image size, FPS, Q-factor, the number of cameras, etc.) specific to each image service type is predetermined. Therefore, the server device 200 requests various images having image qualities corresponding to image service types from the client device 100.

Q-factor is a vector for deciding an image quality, and may be set to any one of 100-1. Q-factor of 100 means the best image quality, and Q-factor of 1 means the worst image quality. Generally, Q-factor of 75 is used for the monitoring service. In the case of the face recognition service or the object recognition service, a Q-factor of 100 is mostly used.

The client device 100 extracts each of a left image and a right image from the image captured by the stereo camera, encodes each of the extracted left and right images into a JPEG format, and transmits the encoded left and right images to the server device 200. The server device 200 receives the JPEG-encoded images from the client device 100, decodes the received images into general images, and provides various image services. Various image services include individual image services

The server device 200 requests an image having a specific image quality from the client device 100, wherein four image services provided from the server device 200 can implement the best performance at the specific image quality. That is, the server device 200 queries the client device 100 for a JPEG stream having an image quality which is the most appropriate for four image services, and the client device 100 generates the JPEG stream, and transmits the generated JPEG stream to the server device 200.

FIG. 3 illustrates image information of various image service categories provided from the server device 200 of an image service system according to an embodiment.

A method for constructing a JPEG stream will hereinafter be described with reference to image information (group map) for each image service type shown in FIG. 3. The oblique-lined areas of FIG. 3 illustrate a maximum number of frames per second (FPS), a maximum image size, and a maximum Q-factor for each service type, respectively.

The server device 200 transmits a group map (See FIG. 3) to the client device 100.

First, the client controller 106 establishes an FPS for image extraction by referring to the group map. The client controller 106 determines FPS values of the left and right images to be an FPS of an image service having a maximum number of frames per second (FPS).

A maximum number of frames per seconds (LEFT_MAX_FRAME) of the left image and the maximum number of frames per seconds (RIGHT_MAX_FRAME) of the right image to satisfy all the four image services can be represented by the following expressions.

### LEFT_MAX_FRAME(A, B, C, D)

### RIGHT_MAX_FRAME(A, C)

In the above-described expressions, A, B, C, and D indicate image service types. Especially, A indicates the navigation service, B indicates the face recognition service, C indicates the object recognition service, and D indicates the monitoring service.

Referring to FIG. 3, in the above-described example, A, B, C, and D services are used in frame images having LEFT_MAX_FRAME information (as denoted by LEFT_MAX_FRAME(A, B, C, D)), and only A and C services are used in frame images having RIGHT_MAX_FRAME information (as denoted by RIGHT_MAX_FRAME(A, C)).

In addition, in the above-described example, the navigation service has a maximum number of frames per second (FPS), such that each of LEFT_MAX_FRAME and RIGHT_MAX_FRAME is set to 20.

FPS may be determined according to whether the image service is operated. If the navigation service is not operated, as shown in FIG. 3, LEFT_MAX_FRAME(B, C, D) and RIGHT_MAX_FRAME(C) are respectively set to 10 and 5 on the basis of the face recognition service or the monitoring service, an FPS of which is lower than that of the navigation service.

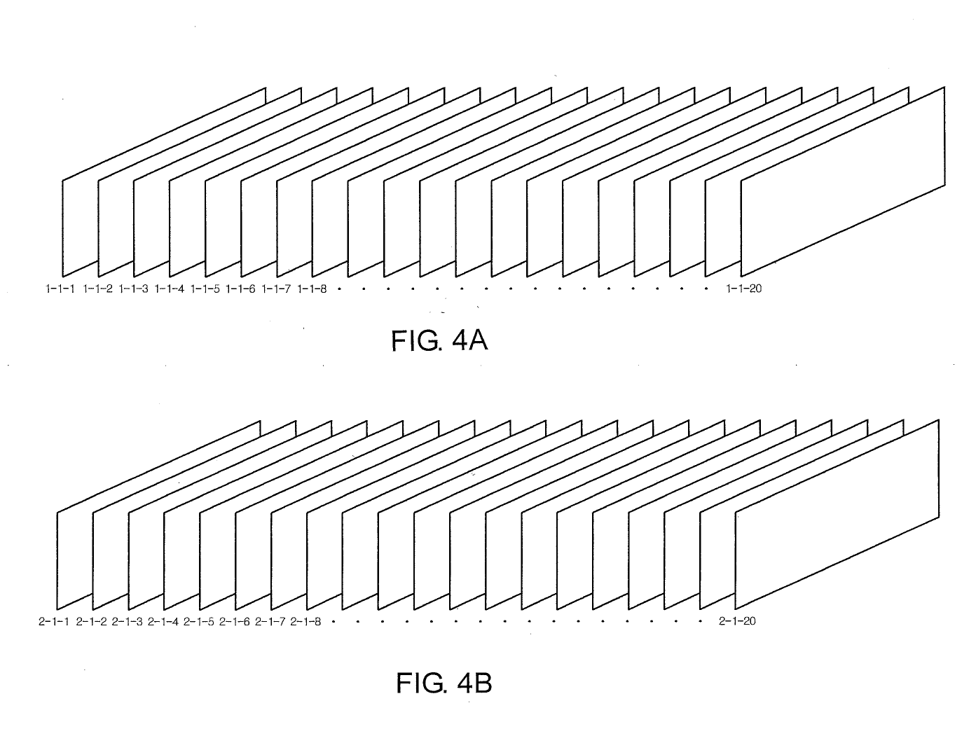

Referring to FIGS. 4A and 4B, the client device 106 extracts a left image and a right image, each of which has a maximum FPS of 20, through the image extracting unit 102, and assigns a unique number (i.e., ID) to each extracted image. The unique number is denoted by “camera ID number-time(sec)-sequence number of the corresponding time”. ‘Camera ID number’ is used to discriminate between the left camera and the right camera. For example, ‘1’means the left camera, and ‘2’ means the right camera. ‘time(sec)’ means a start- or current-time after the camera starts operation. ‘Sequence Number’ means which one of images is obtained at the corresponding time.

For example, if the unique number is ‘1-10-3’, this means that a corresponding image is a third image captured at 10 seconds after the beginning of the image capturing of the left camera. If the unique number is ‘1-20091019171535-5’, this means that a corresponding image is a fifth image captured by the left image at 35 seconds, 15 minutes, 17 o'clock, Oct. 19, 2009 according to an embodiment.

The client controller 106 encodes each frame image into a JPEG format through the encoding unit 103.

The encoding method encodes each of the left image and the right image using both the image size and the Q-factor.

If all the sequence images corresponding to the corresponding time are considered to be one group, individual images contained in the group are used for one or more services. For example, in the case of the left image, a first image of the group is used in all the requested services, such that the image size and the Q-factor which satisfy all the services must be assigned to the first image. The first image must have the largest image size and the highest Q-factor from among those of image services to satisfy A, B, C and D services. Therefore, the first image needs to be encoded in such a manner that 640*480 and Q-factor 100 are assigned to the first image.

As to A, B, C and D services for use in individual frame images, the A service is used in 20 frame images respectively having sequence numbers 1, 2, 3 . . . 20. The B service is used in 10 frame images respectively having sequence numbers 1, 3, 5 . . . 19. The C service is used in 5 frame images respectively having sequence numbers 1, 5, 10, 15, and 20. The D service is used in 10 frame images respectively having sequence numbers 1, 3, 5 . . . 19. In this case, assuming that sequence number of B, C or D service is identical to the number of frames per second (FPS), this sequence number may be set to another number. For example, the sequence numbers of the B service may be set to 1, 2, 3, 4, 5, 10, 11, 12, 13, and 14.

In relation to frame images 1-1-1 to 1-1-20, the image size and the Q-factor are determined on the basis of services used in individual frame images, and each frame image is encoded according to the determined image size and the Q-factor.

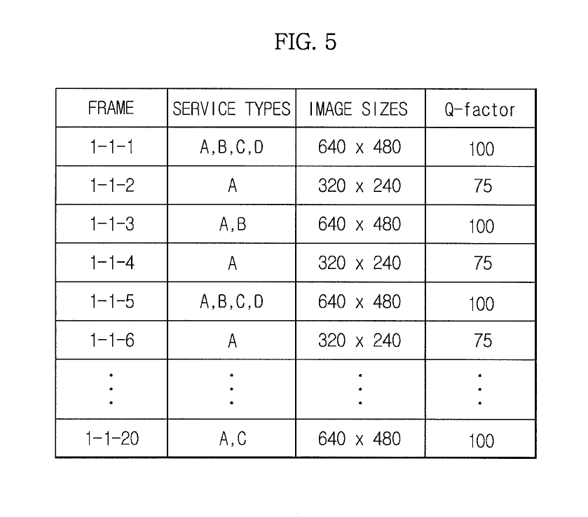

For example, as shown in FIG. 5, frame image ‘1-1-1’ is used in all of A, B, C, and D services, such that the image size is encoded with 640*480 and the Q-factor is encoded with 100. Frame image ‘1-1-2’ is used only in the A service, such that the image size is encoded with 320*240 and the Q-factor is encoded with 75. Frame image 1-1-3 is used only in the A, B and D services, such that the image size is encoded with 640*480 and the Q-factor is encoded with 100. Frame image 1-1-4 is used only in the A service, such that the image size is encoded with 320*240 and the Q-factor is encoded with 75.

Based on the services used in the frame images 2-1-1 and 2-1-20, the image size and the Q-factor are decided. And, each frame of an image is encoded according to the decided image size and Q-factor.

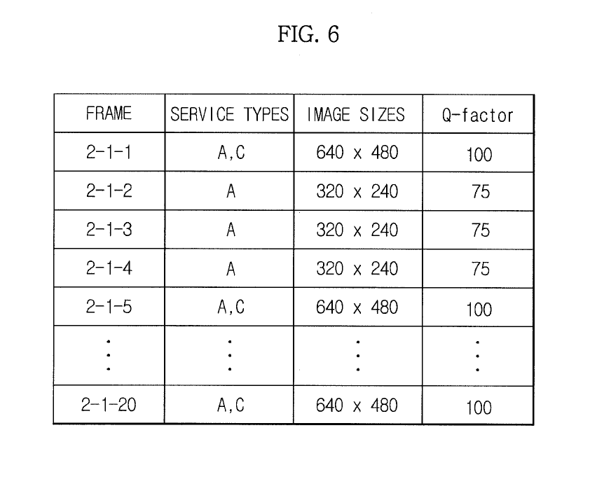

For example, as shown in FIG. 6, the frame image 2-1-1 is used in the A and C services, frame image 2-1-1 is used in the A and C services, such that the image size is encoded with 640*480 and the Q-factor is encoded with 100. In addition, frame image 2-1-2, 2-1-3, and 2-1-4 are used only in the A service, such that the image size is encoded with 320*240 and the Q-factor is encoded with 75. Frame image 2-1-5 and Frame 2-1-20 are used in the A and C services, such that the image size is encoded with 640*480 and the Q-factor is encoded with 100.

The above-mentioned processes are repeated in all seconds constructing one group. This status is referred to as a group map. This group map may be commonly managed by the client device 100 and the server device 200.

The client controller 106 configures the above-mentioned encoded image stream in the form of a packet, and transmits the packet-type image stream to the server device 200 through the transmitter 103. In this case, each image packet transmitted from the client device 100 to the server device 200 includes a header region and a data region. The header region of each image packet stores a unique number, an image size, and a Q-factor. The unique number is denoted by “camera ID number-time(sec)-sequence number of the corresponding time”. The JPEG image is stored in the data region.

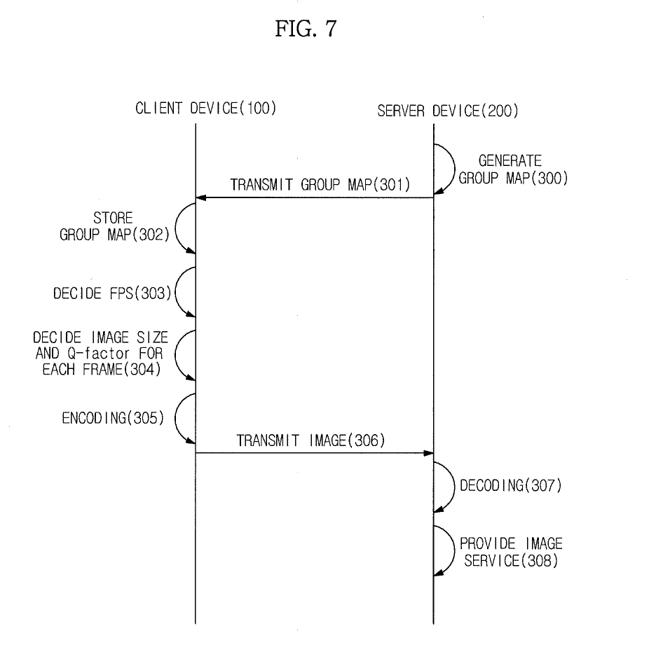

FIG. 7 is a flowchart illustrating an image service method according to an embodiment invention.

Referring to FIG. 7, the server device 200 generates a group map (See FIG. 3) for its own image service at operation 300. The server device 200 transmits the group map to the client device 100 at operation 301. The server device 200 configures a group map for an image sequence, and transmits the group map to the client device 100. The group map may be pre-determined.

The client device 100 receives the group map from the server device 200, and stores the group map at operation 302.

The client device 100 determines an FPS according to a group map at operation 303.

After deciding the FPS, the client device determines an image size and a Q-factor according to group maps for individual frame images, the number of which corresponds to the decided FPS value, at operation 304.

Thereafter, the individual frame images are encoded according to the determined image size and Q-factor for each frame image at operation 305.

The client device 100 transmits the encoded images to the server device 200 at operation 306.

Therefore, the server device 200 receives and decodes the encoded images at operation 307.

The server device 200 provides an image service using the decoded images at operation 308. For example, the server device 200 provides the navigation service (A service) using 20 left images of frame images 1-1-1 to 1-1-20 and 20 right images of frame images 2-1-1 to 2-1-20. In addition, the server device 200 provides the face recognition service (B service) using 10 left images of frame images 1-1-1, 1-1-3, 1-1-5, . . . 1-1-19. The server device 200 provides the object recognition service (C service) using not only 5 left images of frame images 1-1-1, 1-1-5, 1-1-10, 1-1-15, and 1-1-20, but also 5 right images of frame images 2-1-1, 2-1-5, 2-1-10, 2-1-15, and 2-1-20. The server device 200 provides the monitoring service (D service) using 5 left images of frame images 1-1-1, 1-1-5, 1-1-10, 1-1-15 and 1-1-20.

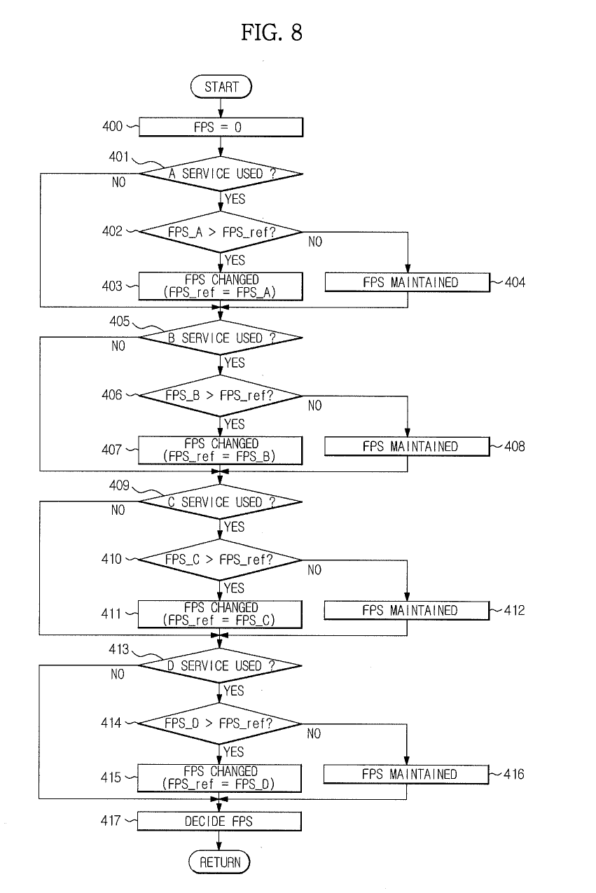

FIG. 8 illustrates a method for deciding Frames Per Second (FPS) according to group maps by a client device 100 of an image service system according to an embodiment.

Referring to FIG. 8, the FPS is determined according to the group map. FPS of each service is confirmed, such that the highest FPS value is determined in relation to the left image and the right image.

First, FPS is set to 0 (FPS=0) at operation 400. It is determined whether the A service is used in the group map at operation 401. If the A service is not used at operation 401, an operation mode goes to operation 405.

Meanwhile, if the A service is used at operation 401, it is determined whether A service's FPS (FPS_A) is higher than a FPS reference number (FPS-ref) (where FPS is initially set to 0 as shown in operation 400) of frames per reference second at operation 402. If FPS_A is higher than FPS_ref, FPS_ref (indicating the number of frames per reference second) is changed to FPS_A (indicating the number of frames per second of A service) at operation 403. Meanwhile, if FPS_A is not higher than FPS_ref, current FPS is maintained at operation 404.

Thereafter, it is determined whether the B service is used in the group map at operation 405. If the B service is not used at operation 405, the operation mode goes to operation 409.

Meanwhile, if the B service is used at operation 405, it is determined whether FPS_B indicating the number of frames per second of the B service is higher than FPS_ref at operation 406. If FPS_B is higher than FPS_ref at operation 406, FPS_ref is changed to FPS_B at operation 407. Otherwise, if FPS_B is not higher than FPS_ref at operation 406, a current FPS is maintained at operation 408.

Thereafter, it is determined whether the C service is used in the group map at operation 409. If the C service is not used at operation 409, the operation mode goes to operation 413.

Meanwhile, if the C service is used at operation 409, it is determined whether FPS_C (indicating the number of frames per second of the C service) is higher than F_ref at operation 410. If FPS_C is higher than FPS_ref at operation 409, FPS_ref is changed to FPS_C at operation 411. Otherwise, if FPS_C is not higher than FPS_ref, a current FPS is maintained at operation 412.

Then, it is determined whether the D service is used in the group map at operation 413. If the D service is not used at operation 413, the operation mode goes to operation 417.

Meanwhile, if the D service is used at operation 413, it is determined whether FPS_D (indicating the number of frames per second of the D service) is higher than FPS_ref at operation 414. If FPS_D is higher than FPS_ref at operation 414, FPS_ref is changed to FPS_D at operation 415. Otherwise, if FPS_D is not higher than FPS_ref, a current FPS is maintained at operation 416.

Thereafter, FPS that finally satisfies the group map service is determined to be a current FPS_ref at operation 417.

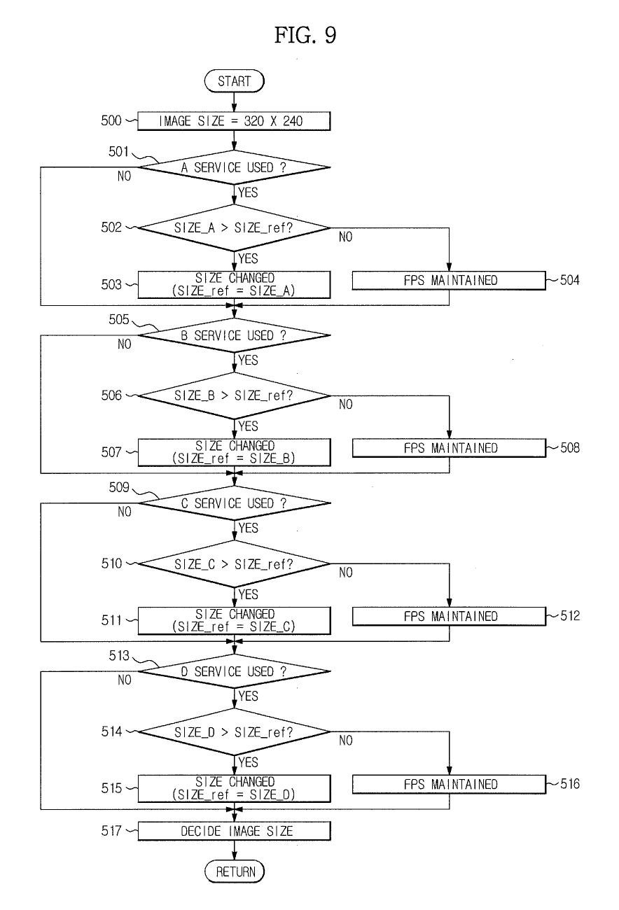

FIG. 9 illustrates a method for deciding an image size for each frame image according to group maps by a client device 100 of an image service system according to an embodiment.

Referring to FIG. 9, the image size is determined for each frame image in the group map. The highest image size value is searched for from among services that use corresponding frame images, such that image sizes for individual frame images are determined. Image sizes for individual frames are determined in the same manner as in the FPS decision method of FIG. 8.

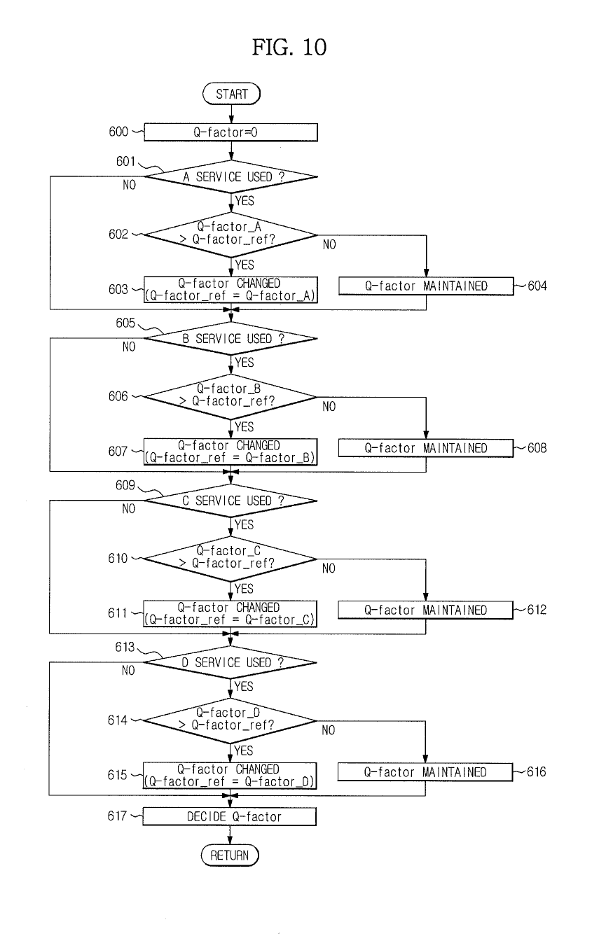

FIG. 10 is a flowchart illustrating a method for deciding a Q-factor for each frame image according to group maps by a client device 100 of an image service system according to an embodiment.

Referring to FIG. 10, Q-factor is determined for each frame image in the group map. The highest Q-factor value is searched for from among individual frame images, such that Q-factor for each frame image is determined. Q factors for individual frames are determined in the same manner as in the FPS decision method of FIG. 8.

As is apparent from the above description, the embodiment differently encodes the quality of an image captured by a camera according to categories of image services, and reduces the file size of the encoded image, resulting in an increase in the transmission efficiency of image.

The embodiment invention allows the client device to differently encode the quality of images transmitted to the server device according to types of image services supplied from the server, such that the file size of the encoded image is reduced, resulting in a reduction in network load between the server and the image service device.

Although a few embodiments invention have been shown and described, it would be appreciated by those skilled in the art that changes may be made in these embodiments without departing from the principles and spirit of the embodiment, the scope of which is defined in the claims and their equivalents.

What is claimed is:

1. A client device comprising:
an image capturing unit to capture an image;
an encoding unit to encode the image captured by the image capturing unit into a compression format according to a group map that includes Frames Per Second (FPS) values used for types of a plurality of image services and compression information for each frame image; and
a client controller to determine the FPS satisfying the plurality of image services and the compression information for each frame image, and control an operation of the encoding unit in such a manner that images captured by the image capturing unit are encoded according to the determined FPS and compression information.

2. The client device according to claim 1, wherein the compression information of the group map includes at least one of an image size and a Q-factor indicating an image quality vector.

3. The client device according to claim 2, wherein the client controller determines the FPS satisfying the plurality of image services to be the highest FPS in the group map.

4. The client device according to claim 2, wherein the client controller, in association with each frame image having the determined FPS, according to the group map, determines an image size of a corresponding frame image to be a maximum image size from among image sizes corresponding to an image service used in the corresponding frame image, and determines a Q-factor of the corresponding frame image to be a maximum Q-factor from among Q-factors corresponding to the image service used in the corresponding frame image.

5. The client device according to claim 1, wherein the compression format is any one of an MPEG and a JPEG format.

6. The client device according to claim 1, the client device further comprising: an image extracting unit to extract the captured image.

7. An image service system comprising:
a receiving unit to receive a group map that includes not only Frames Per Second (FPS) values required for types of a plurality of image services provided from a server but also compression information from the server;
an image capturing unit to capture an image;
an encoding unit to encode the image captured by the image capturing unit into a JPEG format;
a client controller to determine not only the FPS satisfying the plurality of image services but also the compression information for each frame image according to the group map received through the receiving unit, and control an operation of the encoding unit in such a manner that images captured by the image capturing unit are encoded according to the determined FPS and compression information for each frame image; and
a transmitter to transmit the encoded images to the server according to a control signal from the client controller.

8. The client device according to claim 7, wherein the compression information of the group map includes at least one of an image size and a Q-factor indicating an image quality vector.

9. The client device according to claim 8, wherein the client controller determines the FPS satisfying the plurality of image services to be the highest FPS in the group map.

10. The client device according to claim 7, wherein the compression format is any of a JPEG format and MPEG format.

11. The client device according to claim 9, wherein the client controller, in association with each frame image having the determined FPS, according to the group map, determines an image size of a corresponding frame image to be a maximum image size from among image size values corresponding to an image service used in the corresponding frame image, and determines a Q-factor of the corresponding frame image to be a maximum Q-factor from among Q-factors corresponding to the image service used in the corresponding frame image.

12. A method for controlling a client device comprising:
capturing an image;
determining, according to a group map that includes not only Frames Per Second (FPS) values required for types of a plurality of image services and image sizes and Q-factors for individual frame images, the FPS satisfying the plurality of image services, an image size and a Q-factor for each frame image; and
encoding the captured images into a compression format according to the determined FPS and the determined image size and Q-factor for each frame image.

13. The method according to claim 12, wherein the determining of the FPS and the image size and Q-factor for each frame image includes:
determining the FPS satisfying the plurality of image services to be the highest FPS in the group map;
determining, in association with each frame image having the determined FPS, an image size of a corresponding frame image in the group map to be a maximum image size from among image sizes corresponding to an image service used in the corresponding frame image, and determining a Q-factor of the corresponding frame image in the group map to be a maximum Q-factor from among Q-factors corresponding to the image service used in the corresponding frame image.

14. The method according claim 12, wherein the compression format is any one of a JPEG and an MPEG format.

15. An image service method comprising:
receiving a group map that includes not only Frames Per Second (FPS) values required for types of a plurality of image services provided from a server but also an image size and a Q-factor indicating an image quality vector from the server;
determining not only the FPS satisfying the plurality of image services but also an image size and Q-factor for each frame image according to the received group map;
capturing an image;
encoding the captured images into a JPEG format according to the determined FPS and compression information for each frame image; and
transmitting the encoded images to the server.

16. The method according to claim 15, wherein the determining of the FPS and the image size and Q-factor for each frame image includes:
determining the FPS satisfying the plurality of image services to be the highest FPS in the group map; and
determining, in association with each frame image having the determined FPS, an image size of a corresponding frame image in the group map to be a maximum image size from among image sizes corresponding to an image service used in the corresponding frame image, and determining a Q-factor of the corresponding frame image in the group map to be a maximum Q-factor from among Q-factors corresponding to the image service used in the corresponding frame image.
